(19) United States
(12) Patent Application Publication
(10) Pub. No.: US 2013/0193391 A1
(43) Pub. Date: Aug. 1, 2013

(54) METHOD FOR WINDING AND UNWINDING A SYNTHETIC ROPE ON A WINCH DRUM

(71) Applicants: Stephan Frans Fok, Teteringen (NL); Paulus Johannes Hyacinthus Marie Smeets, Geulle (NL)

(72) Inventors: Stephan Frans Fok, Teteringen (NL); Paulus Johannes Hyacinthus Marie Smeets, Geulle (NL)

(21) Appl. No.: 13/580,019

(22) PCT Filed: Feb. 24, 2011
(86) PCT No.: PCT/EP2011/052764

§ 371 Date: Oct. 31, 2012

(30) Foreign Application Priority Data
Feb. 24, 2010 (EP) 10001894.4

(51) Int. Cl. B66D 1/38

(52) U.S. Cl. CPC B66D 1/38
USPC 254/266; 242/476.7

(57) ABSTRACT

The invention relates to a method for winding and unwinding a synthetic rope on a winch drum of a winch. The rope is helically wound with a substantially constant speed across the width of the drum back and forth such that in a coiled state of the winch the drum comprises several layers of rope. The spacing between windings of the rope is at least 0.5 times the diameter of the rope.

The invention relates to a method for winding and unwinding a synthetic rope on a winch drum of a winch, wherein the rope is helically wound with a substantially constant speed across the width of the drum back and forth such that in a coiled state of the winch the drum comprises several layers of rope.

The invention further relates to a winch assembly.

A winch is a mechanical device that is used to pull in (wind up) or let out (wind out) or otherwise adjust the “tension” of a rope or wire rope, also called “cable” or “wire cable”. The winch always comprises a spool that can also be called a winch drum. More elaborate winch designs have gear assemblies and can be powered by electric, hydraulic, pneumatic or internal combustion drives. A winch suited to be used with synthetic ropes is for example known from U.S. Pat. No. 7,134,645.

It is well known to use synthetic ropes such as a rope made with UHMWPE (e.g. Dyneema®) which rope is as strong as a wire steel rope with the same diameter but only about 10% of the weight per unit length. In particular, the advantageous weight per unit length ratio of synthetic ropes is beneficial in deep sea, mining and crane applications. Such applications require relatively long lengths of rope, i.e. for example more than 1000 metres. The power to be used for lowering and lifting loads to be handled with the winch having a synthetic rope having such a relatively long length, is much lower than the power to be used in a winch having a wire rope of the same length. Also the payload can be increased substantially.

WO2008/040349 describes a hoisting device having a frame that carries a reel or drum. A hoisting line is wound on the reel in one or more layers in such a manner that the line is arranged in turns next to each other.

A drawback of synthetic ropes on a winch for storing many layers of rope is that synthetic ropes are slippery and/or not form stable. If many layers of rope are stored in a pattern as e.g. shown in U.S. Pat. No. 7,134,645 or WO2008/040349, the risks exists that rope is going to slip during winding or unwinding of the winch, which is dangerous and undesired in particular if one of the two ends of the rope is carrying a load. A second drawback of synthetic ropes on a winch is that the rope tends to get buried into the underlying layer of rope, thereby diminishing stability of the winch system (rope and winch).

It is therefore an object of the present invention to provide a method for winding and unwinding a synthetic rope on a drum of a winch wherein the possibility of slipping and/or burying in of synthetic ropes is minimised.

This object is accomplished with the method according to the present invention in that the spacing between windings of the rope is at least 0.5 times the diameter of the rope.

By applying the spacing between windings equal to or larger than the 0.5 times the diameter of the rope a coiling and crossing pattern of the rope is created which minimises the possibility of slipping of synthetic ropes over each other and/or over the drum surface and/or minimises burying in of synthetic ropes. Preferably, this spacing between windings is substantially constant both in a first layer coiled in a forward helical pattern as in a second layer coiled in a backward helical pattern and in any other subsequent layer. Due to this constant and in relation to the rope diameter relatively large spacing between windings, each winding of a second layer crosses over a winding of the first layer twice. Each subsequent winding of the second layer will be wound in a similar manner, that is, each winding will cross twice over one winding of the first layer. In this way each winding of the first layer is locked by a winding of the second layer at the crossings. This winding or coiling pattern continues for every subsequent layer such that many layers may be stored on the winch drum and the risk of slippage and burying in is minimised.

In addition, a rope is distributed evenly over the surface of the drum in each layer into eventually a cylindrical package comprising many rope layers by means of the method according to the present invention. As the diameter of the drum grows with each layer, the position where windings cross each other in different layers displaces automatically resulting in more even distribution of winding crossings over the drum surface.

Preferably, the spacing between windings of the rope substantially equals the diameter of the rope, as this creates the most even coiling and crossing pattern and therefore distribution of rope across the drum surface.

In the context of this specification, “rope” includes cables, wires and like elongate tensile elements. “Drum” includes any spool or reel about which such a rope can be wound.

With the “diameter” of the rope is meant the broadest dimension of the rope when measured in transverse direction of the rope length. This applies in particular if the rope is not perfectly circular, i.e. when the rope has a more oblong shape, or when the shape of the rope is somewhat irregular. The rope diameter can easily be determined by a skilled person.

With synthetic rope is meant a rope that is made of synthetic yarns. Synthetic yarns that may be used in rope according to the invention include all yarns, which are known for their use in fully synthetic ropes. Such yarns may include yarns made of fibers of polypropylene, nylon, polyester. Preferably yarns of high modulus fibers are used, such as for example yarns of fibers of liquid crystal polymer (LCP), aramid, high molecular weight polyethylene (HMwPE), ultra-high molecular weight polyethylene (UHMwPE) and PBO (poly(p-phenylene-2,6-benzobisoxazole). The high modulus fibers preferably have a tensile modulus of at least 2 MPa.

By fiber is herein understood an elongate body, the length dimension of which is much greater that the transverse dimensions of width and thickness. Accordingly, the term fiber includes filament, ribbon, strip, band, tape, and the like having regular or irregular cross-sections. The fibers may have continuous lengths, known in the art as filaments, or discontinuous lengths, known in the art as staple fibers. Staple fibers are commonly obtained by cutting or stretch-breaking filaments. A yarn for the purpose of the invention is an elongated body containing many fibers.

Best results are obtained if a yarn of gel spun fibers of high or ultra high molecular weight polyolefin, preferably HMwPE or UHMwPE yarns are used in the rope.

The gel spinning process is described in for example GB-A-2042414, GB-A-2051667, EP 0205960 A and WO 01/73173 A1. This process essentially comprises the preparation of a solution of a polyolefin of high intrinsic viscosity, spinning the solution to filaments at a temperature above the dissolving temperature, cooling down the filaments below the gelling temperature so that gelling occurs and drawing the filaments before, during or after removal of the solvent.

The shape of the cross-section of the filaments may be selected here through selection of the shape of the spinning aperture.

Preferably HMwPE is used with an intrinsic viscosity of at least 5 dl/g, determined in decalin at 135° C., and a yarn titre of at least 50 denier, with the yarn having a tensile strength of at least 25, more preferably at least 30, even more preferably at least 32, even more preferably at least 34 cN/dtex and a tensile modulus of at least 1000 cN/dtex.

The intrinsic viscosity is determined according to PTC-179 (Hercules Inc. Rev. Apr. 29, 1982) at 135° C. in decalin, the dissolution time being 16 hours, the anti-oxidant is DPBC, in an amount of 2 g/l solution, and the viscosity is measured at different concentrations and is extrapolated to zero concentration.

In a preferred embodiment of the method according to the present invention the helically wound rope comprises a helical angle larger than 75 degrees, more preferably at least 80 degrees, with respect to the axis of the drum.

By means of the helical angle larger than 75 degrees an anti-slip coiling and crossing pattern of the rope is created, as the angle between two windings crossing each other is relatively small, i.e. smaller than 30 degrees. Further, this helical angle ensures that a rope guide for distributing the rope over the drums surface by means of displacement along the drum in synchronism with the rotation of the latter, does not or hardly not have to move outside the width of the drum such that it is possible to use a drum having flanges provided at both ends thereof. Using flanges has the advantage that the rope is stabilized on the drum, i.e. there is less risk of the rope slipping off the drum. This in particular advantageous in view of the angle in which the rope is wound on the drum. In addition, such a helical angle assures a small angle between the rope to be wound and a collar part provided at both ends of the winch drum such that a rope can be positioned in an easy, stable and secure way against the collar parts.

The maximum angle of winding can be as much as 89 degrees.

It is a further object of the present invention to provide a winch assembly for winding and unwinding a rope on a winch drum of a winch wherein slipping of synthetic ropes is minimised.

This object is accomplished with the winch assembly according to the present invention in that the winch assembly comprises a winch drum and a guide for guiding a synthetic rope over the winch drum by movement of the guide in an axial direction of the winch, wherein the guide comprises a control system for controlling the speed of movement of the guide in an axial direction of the winch drum for executing the method as described above.

The winch assembly according to the present invention is in particular suited for handling ropes made with UHMWPE. These UHMWPE ropes have excellent strength and have a superior weight per unit length ratio making such ropes ideal for deep sea applications in which over more than thousand metres of rope is needed.

The invention will now be explained in more detail with reference to an exemplary embodiment shown in the appended figures, in which:

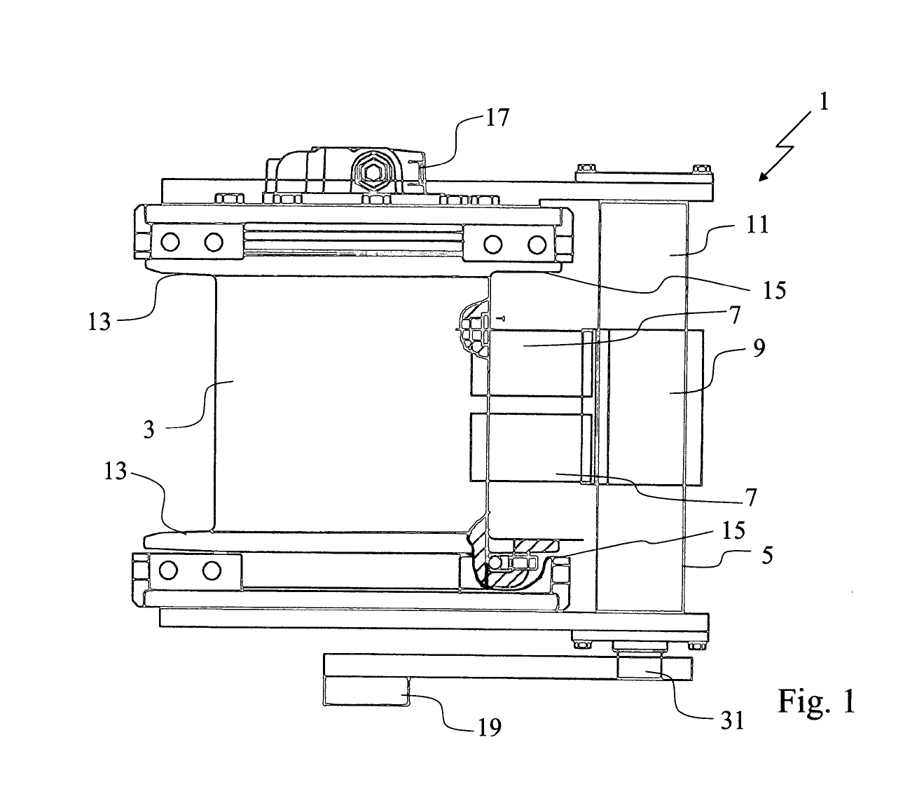

FIG. 1 shows a top view of a winch assembly according to the invention,

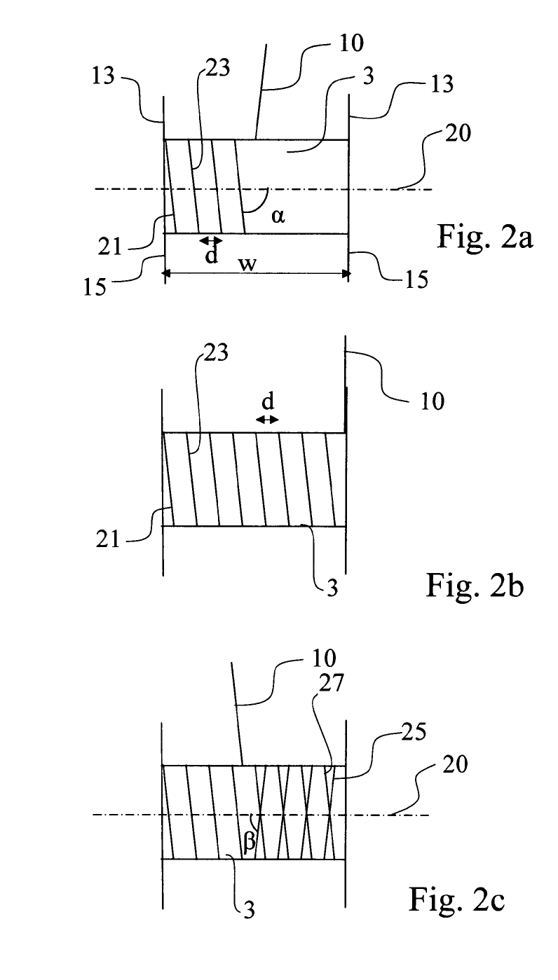

FIG. 2a-c show schematic views of the method according to the present invention for winding and unwinding a synthetic rope on a drum.

Like parts are indicated by the same numerals in the various figures.

Referring to the drawings in detail, and particularly FIG. 1, a winch assembly 1 is shown which winch assembly 1 comprises a winch drum 3 and a rope guide 5.

The rope guide 5 is constituted of a pair of rope guide members 7 mounted on a carriage 9 comprising a bearing which can slide along a cylindrical shaft 11 parallel with the drum 3. The rope guide 5 is driven by means of a control system 19. The control system 19 controls the speed of movement of the guide members 7 moving back and forth in an axial direction of the winch drum 3. This speed depends mainly on the diameter of the rope 10 (not shown in FIG. 1) and/or the diameter of the winch drum 3 and this speed remains substantially constant during winding/unwinding of a specific rope 10 on a specific drum 3.

The winch drum 3 comprises collar parts 13, 15 provided at both ends thereof. Further, the winch drum 3 comprises a motor 17 for driving the winch drum 3.

By means of said rope guide members 7 of the guide 5 a synthetic rope, preferably made with UHMWPE, is moved over the winch drum 3 in a manner as shown in FIGS. 2a-c. FIGS. 2a-c are only schematic views to explain the winding/unwinding process and many details of the winch assembly 1 are not shown therein.

As shown a synthetic rope 10 is being wound on a winch drum 3, wherein the rope 10 is helically wound with a helical angle (α) in relation to the axis 20 of the drum 3 across the width (w) of the drum 3 back and forth such that in a coiled state of the winch (not shown) the drum 3 comprises several layers of rope. Generally at least 2, but preferably 2-30, more preferably about 15-30 layers will be wound. The spacing (d) between windings such as a first winding 21 and a second winding 23 is preferably equal to or larger than the 0.5 diameter of the rope. The spacing between windings in every layer is substantially constant. In the example shown in FIGS. 2a-c the spacing between windings is about six times the diameter of the rope 10. In a preferred embodiment (not shown in the figures) the spacing between windings is approximately equal to the diameter of the rope.

The helical angle (α) in the example shown is approximately 80 degrees with respect to the axis 20 of the drum 3.

Due to this constant spacing between windings of the rope, the first winding 25 of a second layer starts to follow the spacing between the last winding 27 of a first layer and the collar 13, 15 in a backward helical pattern with a helical angle (β) in relation to the axis 20 of the drum 3 across the width (w) of the drum 3. The helical angle (β) of the backward helical pattern is substantially equal to the helical angle (α) of the forward helical pattern in a reversed manner. Subsequently, the first winding 25 of the second layer crosses said last winding 27 of the first layer twice. Each subsequent winding of the second layer will be wound in a similar manner, that is, each winding will cross over a winding of the first layer twice. In this way each winding of the first layer is locked by the crossings of a winding of the second layer such that slippage of the synthetic rope windings over each other and over the drum surface or flange surface is minimised.

Although each layer is wound with a constant helical angle, it is possible that during the winding process the helical angle for a specific set of layers is varied within a preferred range of 75-85 degrees.

Unwinding rope from the winch drum follows the same process as winding rope on the winch drum in a reversed direction.

The diameter of the rope is preferably larger than 0.5 mm. The diameter is e.g. between 0.5-1 mm for applications like fishing lines, kite lines or ropes for yachts. For applications like cranes, the diameter of the rope can be from 10 mm to 300 mm.

Further, it is possible to provide a groove or the like on the drum surface for guiding the rope thereon in a pattern according to the present invention.

In addition, it is possible to couple the rotary axis of the drum 3 driven by motor 17 with the axis 31 of the cylindrical shaft 11. In this way no control system 19 is needed as the cylindrical shaft 11 is driven by means of motor 17 in a synchronous way. In such a embodiment the crossing moments of the rope windings can be varied by varying the diameter of the cylindrical shaft 11.

1. Method for winding and unwinding a synthetic rope on a winch drum of a winch, wherein the rope is helically wound with a substantially constant speed across the width of the drum back and forth such that in a coiled state of the winch the drum comprises several layers of rope, characterised in that the spacing between windings of the rope is at least 0.5 times the diameter of the rope.

2. Method according to claim 1, characterised in that the spacing between windings of the rope substantially equals the diameter of the rope.

3. Method according to claim 1, characterised in that the spacing between the windings is maximally 7 times the diameter of the rope.

4. Method according to claim 1, characterised in that the spacing between windings of the rope is substantially constant in any layer.

5. Method according to claim 1, characterised in that the helically wound rope comprises a helical angle larger than 75 degrees, more preferably at least 80 degrees, with respect to the axis of the drum.

6. Winch assembly comprising a winch drum and a guide for guiding a synthetic rope over the winch drum by movement of the guide in an axial direction of the winch, wherein the guide comprises a control system for controlling the speed of movement of the guide in an axial direction of the winch drum for executing the method as described in claim 1.

7. Winch assembly according to claim 6, characterised in that the synthetic rope is a rope made with ultra high molecular weight polyethylene (UHMWPE).
